(19) United States
(12) Patent Application Publication
(10) Pub. No.: US 2006/0089202 A1
(43) Pub. Date: Apr. 27, 2006

(54) Constant velocity universal joint system

(75) Inventor: Gilbert E. Losi JR., Upland, CA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Horizon Hobby, Inc.

(21) Appl. No.: 11/115,727

(22) Filed: Apr. 27, 2005

Related U.S. Application Data
(60) Provisional application No. 60/621,803, filed on Oct. 25, 2004.

(51) Int. Cl. F16D 3/62

(52) U.S. Cl. 464/114

(57) ABSTRACT

A constant velocity universal joint system and method of substantially eliminating a pulsating angular velocity difference in such system comprises an input universal joint including an input shaft, an input coupling, and an input drive pin, and an output universal joint including an output shaft, an output coupling, and an output drive pin. A tubular coupler couples the input universal joint to the output universal joint, and the tubular coupler has a passage therethrough, and an end of the input and output shafts, the input and output couplings and the input and output drive pins as positioned in the passage. The input drive pin couples the input coupling to the coupler, and the input coupling couples the input shaft to the input drive pin such that the input shaft can both tilt and rotate relative to the input drive pin. The output drive pin couples the output coupling to the coupler, and the output coupling couples the output shaft to the output drive pin such that the output shaft also can both tilt and rotate relative to the output drive pin. A substantially spherical projection is positioned on an end of one of the shafts and a receptacle is positioned on an end of the other of the shafts. The projection extends into the receptacle when at least one of the shafts tilts or rotates to support the shafts, and the projection and receptacle are positioned in the coupler passage. The end of the input and output shafts has a first opening to receive the input and output couplings respectively therein, and a second opening in the ends to receive the input and output drive pins respectively therethrough, the first and second openings also are positioned in the coupler passage, and the second openings are slotted to permit the ends of the input and output shafts to tilt relative to their respective drive pins. The ends of the input and output shafts which include the first and second openings are also substantially spherical and are positioned in the coupler passage, and the drive pins are fixed against movement along their axis relative to the coupler either by a screw in the input and output couplings or by heat shrinkable tubing which is heat shrunk about the coupler.

### RELATED APPLICATION

This application claims the benefit of U.S. provisional application Ser. No. 60/621,803, filed Oct. 25, 2004.

### BACKGROUND AND SUMMARY OF THE INVENTION

The present invention is directed to a constant velocity universal joint system for use in mechanical power transmission and/or drive systems.

Current constant velocity universal joint systems utilize two standard universal joints which typically require radial support on both axles of the joint in the form of bearings which support the respective input and output drive shafts. This requirement makes such systems impractical or unusable in certain applications, such as in the mechanical drives of radio controlled model cars due to the extra weight, space requirements and costs that would be required for the radial support on both axles.

For this reason current solutions in such applications are generally some variation of a single universal joint, also called a Cardan or Hooke's joint. However, such single universal joints result in a pulsating angular velocity difference between the input and output shafts as the angle between the shafts increases during operation. When both shafts are in generally axial alignment with each other, there is no pulsating angular velocity difference between the shafts because they operate effectively as a single axially aligned shaft. However, when the angle between the shafts increases, the velocity on the output shaft will speed up and slow down during each revolution. This velocity difference between the shafts will produce vibration and pulsation. These vibrations and pulsations due to angular velocity difference result in elevated wear of the drive train components and greatly decreases the efficiency of the overall drive system. Such loss in efficiency is detrimental in, for example, radio controlled model car applications which are battery powered because the battery only has a limited fixed capacity. Therefore, the decrease in efficiency due to pulsating angular velocity differences consumes the battery energy earlier than if greater efficiencies were realized. If it is possible to reduce the pulsating angular velocity difference and the vibrations and pulsations resulting therefrom, either a more powerful motor may be employed or the range of operation could be extended with the same battery capacity. Another disadvantage of pulsating angular velocity differences is that the handling of the vehicle is also affected.

The present invention is directed to a constant velocity universal joint system which effectively cancels the angular differences between the input and output shafts and the vibrations and pulsations which result from such differences.

In the constant velocity universal joint system of the preferred embodiment of the present invention, two universal joints are employed in a 90-degree phase difference, one of which is attached to the input shaft and the other to the output shaft. These joints are constrained by mounting them to a tubular coupler that effectively functions as a third intermediate shaft between the two joints. In order to achieve as close as possible to a true constant angular velocity with these two standard universal joints, the joint angles are kept equal or close to equal by placing the input and output shafts in physical contact and support with each other by way of a spherical male projection on the end of one of the shafts and a female receptacle on the end of the other shaft. The spherical male projection and the female receptacle interfit with and contact each other during operation to keep the joint angles equal or close to equal as possible through the entire travel of the shafts.

By this arrangement in the present invention, weight, space and cost are substantially reduced from the current two universal constant velocity joint systems, yet substantially true and constant angular velocity may be maintained and thus avoid the pulsating angular velocity differences which are experienced by the prior single universal joint systems.

Accordingly, in one principal aspect of the present invention, a constant velocity universal joint system and method of substantially eliminating a pulsating angular velocity difference in such system comprises an input universal joint including an input shaft, an output universal joint including an output shaft, and a coupler coupling the input universal joint to the output universal joint. The input and output shafts are positioned relative to each other so that they engage each other to support each other when at least one of the shafts is moved at an angle relative to the other shaft.

In another principal aspect of the present invention, the input universal joint also includes an input coupling and an input drive pin, and the output universal joint includes an output coupling and an output drive pin. The input drive pin couples the input coupling to the coupler, and the input coupling couples the input shaft to the input drive pin such that the input shaft can both tilt and rotate relative to the input drive pin. The output drive pin couples the output coupling to the coupler, and the output coupling couples the output shaft to the output drive pin such that the output shaft can both tilt and rotate relative to the output drive pin. The input and output shafts engage each other to support each other when at least one of the shafts tilts or rotates relative to its drive pin.

In still another principal aspect of the present invention, the system and method include a projection on an end of one of the shafts, and a receptacle on an end of the other of the shafts, and the projection extends into the receptacle and engages the receptacle when at least one of the shafts tilts or rotates to support the shafts.

In still another principal aspect of the present invention, the projection and the receptacle are substantially spherical.

In still another principal aspect of the present invention, an end of the input and output shafts has a first opening to receive the input and output couplings respectively therein, and a second opening in the ends to receive the input and output drive pins respectively therethrough.

In still another principal aspect of the present invention, the second openings are slotted to permit the ends of the input and output shafts to tilt relative to their respective drive pins.

In still another principal aspect of the present invention, the ends of the input and output shafts which include the first and second openings are substantially spherical and are positioned in the coupler.

In still another principal aspect of the present invention, at least one limit stop limits the degree of tilt of the shafts.

In still another principal aspect of the present invention, the limit stop is on the shafts and/or the coupler.

In still another principal aspect of the present invention, the drive pins are fixed against movement along their axis relative to the coupler by a screw in the input and output couplings respectively and/or by tubing which is shrunk about the coupler.

These and other objects, features and advantages of the present invention will be more clearly understood through a consideration of the following detailed description.

### BRIEF DESCRIPTION OF THE DRAWINGS

In the course of this description, reference will frequently be made to the attached drawings in which:

FIG. 1 is an exploded perspective view of a preferred embodiment of constant velocity universal joint system of the present invention;

FIG. 2 is an assembled cross-sectioned side elevation view of the system substantially as shown in FIG. 1; and

FIG. 3 is a broken assembled cross-sectioned side elevation view of a second preferred embodiment of constant velocity universal joint system of the present invention.

### DESCRIPTION OF THE PREFERRED EMBODIMENTS

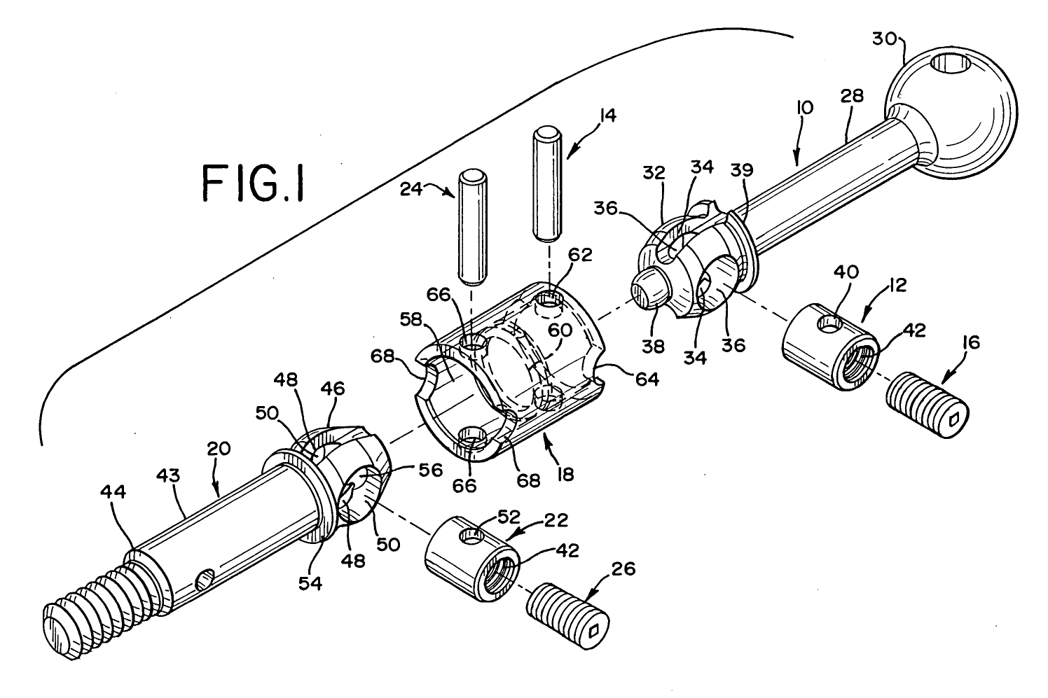

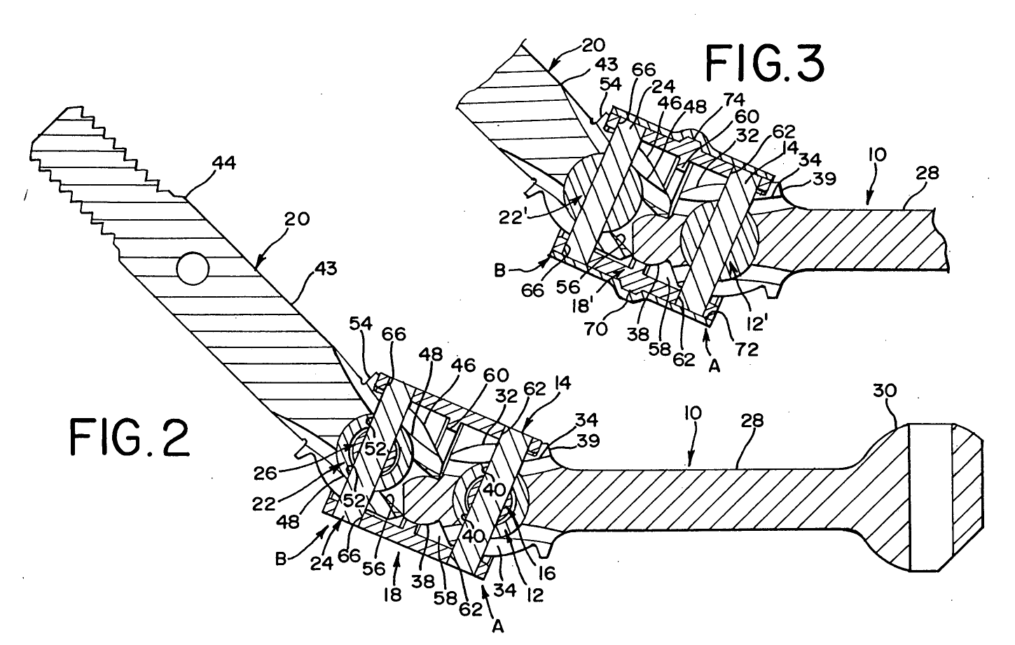

As shown in FIGS. 1 and 2, one preferred embodiment of constant velocity universal joint system of the present invention generally comprises the following components: 1) an input universal joint A comprising an input shaft 10, an input coupling 12, an input drive pin 14, and an input set screw 16; 2) a coupler 18; and 3) an output universal joint B comprising an output shaft 20, an output coupling 22, an output drive pin 24, and an output set screw 26.

The input shaft 10 includes an elongate shaft portion 28 which is formed at one end with a suitable coupling link 30 for coupling the input shaft 10 to a drive axle (not shown) of a vehicle or other device for transmitting rotational mechanical power to the system. The coupling link 30 may take any one of a number of desired forms and may be formed integrally with the elongate shaft portion 28 as shown or may be attached to the shaft portion 28 as a distinct element.

The input shaft 10 has a generally spherical head 32 at the other end opposite the coupling link 30. The spherical head 32 is formed with slotted openings 34 on opposite sides of the head 32 to receive the input drive pin 14 through the head 32 and permit the head and its elongate shaft portion 28 to angularly tilt and to rotate relative to the axis of the input drive pin during operation. The spherical head 32 also includes openings 36 through opposite sides thereof and 90° from the slotted openings 34 to receive the input coupling 12 therethrough.

The spherical head 32 of the input shaft 10 further includes a generally spherical male projection 38 which projects from the end of the spherical head 32. In the preferred embodiment the male projection 38 is somewhat smaller in diameter than the spherical head 32.

The input coupling 12 is generally cylindrical in nature and has an outer diameter which is similar in size to the diameter of the openings 36 in the spherical head 32 to permit it to be inserted through the openings 36 with a relatively close fit as seen in FIG. 2. The input coupling 12 also includes openings 40 on opposite sides to permit the drive pin 14 to be inserted therethrough as shown in FIG. 2. The interior of the input coupling 12 has threads 42 to receive the threaded input set screw 16 therein to hold the input drive pin in fixed stationary relationship with the input coupling 12 when the drive pin has been inserted through the openings 40 in the input coupling 12.

A limit collar 39 is also preferably formed at the end of the elongate shaft portion 28 adjacent the spherical head 32 to limit the maximum angular movement of the components of the system as will be described in further detail to follow. The limit collar 39 preferably is formed as a projecting annular ring. However, it will be understood that it may take the form of a plurality of closely spaced fingers or projections around the circumference of the elongate shaft portion 28.

The output shaft 20 is also formed of an elongate shaft portion 43 which at one end has a coupling construction 44 for coupling the shaft to the wheel or other element which is to receive the rotational energy which is to be imparted to it through the joint system of the present invention.

The end of the output shaft 20 opposite the coupling construction 40 is also formed with a generally spherical head 46 which, like the spherical head 32 on the input shaft 10, includes slotted openings 48 on opposite sides thereof to receive the output drive pin 24 through the head 46 and permit the head and its elongate shaft portion 43 to angularly tilt and to rotate relative to the axis of the output drive pin during operation. The spherical head 46 also includes openings 50 on opposite sides thereof and 90° from the slotted openings 48 to receive the output coupling 22 therethrough with a relatively close fit as seen in FIG. 2. Once the output coupling 22 is positioned through the openings 50 in the spherical head 46 of the output shaft 20, the output drive pin 24 is inserted through the openings 52 in the output coupling 22, and the drive pin 24 and coupling 22 are held in fixed stationarily relationship to each other by the set screw 26.

The elongate shaft portion 43 of the output shaft 20 also includes a limit collar 54 adjacent the spherical head 46 which is preferably of similar construction to the limit collar 39 of the input shaft 10.

In contrast to the spherical male projection 38 on the spherical head 32 of the input shaft 10, the spherical head 46 of the output shaft 20 contains a female receptacle 56 as best seen in FIG. 2. The female receptacle 56 receives the spherical projection 38 therein and is of a size such that its inner surface is in contact with some portion of the exterior surface of the spherical male projection 38 during operation. As a result of this contact, the shafts support each other during operation.

The coupler 18 is generally cylindrical in form and includes an elongate passage 58 therethrough which at one end receives the spherical head 32 of the input shaft 10, and at the other end receives the spherical head 46 of the output shaft 20 as best seen in FIG. 2. The passage 58 of the coupler 18 also preferably includes an annular ridge 60 extending inwardly from the inner wall of the passage and intermediate its length. The annular ridge 60 assists the limit collars 39 and 54 to limit the maximum angular movement of the shafts relative to each other by contact of the spherical male projection 38 with the ridge 60 as seen in FIG. 2. By limiting the maximum angular movement, the limit collars 39 and 54 and the annular ridge 60 prevent the spherical male projection 38 and the female receptacle 56 from separating during operation.

Openings 62 extend through opposite sides of the coupler 18 at one end of the coupler to receive the input drive pin 14 therethrough. At that end openings 64 also extend through opposite sides of the coupler 18 at 90° from openings 62 to receive the set screw 16 when the spherical head 32 of the input shaft 10 and its input coupling 12 are positioned in the passage 58 of the coupler 18. Openings 66 also extend through opposite sides of the other end of the coupler 18 to receive the output drive pin 24 therethrough. Also at the other end of the coupler 18, openings 68 positioned 90° from the openings 66 extend through the coupler 18 to receive the set screw 26 when the spherical head 46 of the output shaft 20 and its output coupling 22 are positioned in the passage 58 of the coupler 18.

To assemble the constant velocity universal joint system of the preferred embodiment of the present invention, the input coupling 12 is inserted through the openings 36 of the spherical head 32 and the spherical head 32 of the input shaft 10 with the input coupling therein is inserted into its end of the passage 58 of the coupler 18 as seen in FIG. 2; the drive pin 14 is inserted through the openings 62 of the coupler 18, through the slotted openings 34 of the spherical head 32, and the openings 40 in the input coupling 12; and the input set screw 16 is passed through one of the openings 64 in the coupler 18 and threaded into the threads 42 of the input coupling 12 to lock the input drive pin 14 into stationary relationship with the input coupling 12. This locking with the set screw 16 also prevents the input drive pin 14 from removal from the openings 62 of the coupler 18 and movement of the pin 14 along its axis and relative to the coupler 18. However, when so assembled, the spherical head 32 of the input shaft 10 can tilt about the input drive pin 14 because of the slotted openings 34, and can also rotate about the axis of the drive pin 14 during operation, thus providing three degrees of movement.

Assembly continues by inserting the output coupling 22 through the openings 50 in the spherical head 46 of the output shaft 20. The spherical head 46 of the output shaft 20 with the input coupling therein is then inserted into the other end of the passage 58 of the coupler 18 and so that the spherical male projection 38 of the spherical head 32 is positioned within the female receptacle 56 of the spherical head 46 as seen in FIG. 2. The output drive pin 24 is then inserted through the openings 66 in the coupler 18, the slotted openings 48 in the spherical head 46 and the openings 52 in the output coupling 22; and the set screw 26 is passed through one of the openings 68 in the coupler 18 and threaded into the threads 42 in the output coupling 22 to lock the drive pin 24 and coupling 22 into stationary relationship with each other. This locking with the set screw 26 also prevents the output drive pin 24 from removal from the openings 66 of the coupler 18 and movement of the pin 24 along its axis and relative to the coupler 18. As in the input shaft 10, when the output shaft 20 is so assembled, the spherical head 46 can tilt about the output drive pin 24 because of the slotted openings 48, and can also rotate about the axis of the drive pin 24, again providing three degrees of movement during operation.

It will be appreciated that the assembly steps may be reversed if desired by assembling the output side first followed by the input side.

When the constant velocity universal joint system has been assembled as shown in FIG. 2, rotational mechanical power is imparted through the input shaft 10 and transmitted through the system to whatever is being rotatably driven by the output shaft 20. If both the input shaft 10 and the output shaft 20 are in axial alignment with each other, there would be no velocity difference between the two shafts and they would act as a common shaft.

However, if the output shaft 20 is angularly moved in one direction or the other, such as where the wheel of a vehicle which is being driven by the output shaft encounters a bump or a hole in the roadway, the angular relationship of the two shafts will be altered so that they are no longer in perfect axial alignment. This angular relationship between the shafts could now give rise to a pulsating angular velocity difference between the input and output shafts which varies in magnitude depending on the degree of the angular difference between the shafts. However, this pulsating angular velocity difference is effectively cancelled by the system of the present invention.

By way of example if the spherical male projection 38 and female receptacle 56 of the present invention were not provided, the spherical head 32 of the input shaft 10 and spherical head 46 of the output shaft 20 would move relatively independently of each other so as to only be limited by the presence of the coupler 18 and the limit collars 39 and 54. Thus, the angular relationship of these shafts to each other might be for example X° and would be at a maximum when the limit collar of the input shaft 10 contacts the upper edge of the coupler 18 as seen in FIG. 2, and the limit collar 54 of the output shaft 20 contacts the lower edge of the coupler 18, or vice versa. However, in the preferred embodiment of the present invention this angular relationship is substantially limited by the supporting engagement of the spherical male projection 38 with the walls in the female receptacle 56 as shown in FIG. 2 as the angular relationship increases when the respective shafts move out of axial alignment with each other. In other words, this engagement restrains the input shaft 10 and output shaft 20 from moving relatively independently of and opposite to each other while maintaining equal or close to equal joint angles.

Although the system as viewed in FIG. 2 is two dimensional, it will be appreciated that because of the spherical nature of the spherical male projection 38 and rounded walls of the female receptacle 56 and the three degrees of movement of the spherical heads 32 and 46, the action of the system of the present invention will be fully three dimensional.

It should also be appreciated that although the heads 32 and 46 and the male projection 38 have been described as “spherical”, they may not be spherical in their entirety as can be seen in the drawings. For example the male projection 38 may be flattened at this furthest end because that end does not contact the wall of the female receptacle 56 during its range of operation, but it must remain clear of the forward surface of the output coupling 22 during operation. Forward portions of the heads 32 and 46 for example also may include flats as can be seen in the drawings.

It will also be appreciated that although the spherical male projection 38 as described is positioned on the spherical head 32 of the input shaft 10 and the female receptacle 56 is positioned in the spherical head 46 of the output shaft 20, such positioning may be reversed without departing from the invention. Moreover, although the spherical male projection 38 and the female receptacle 56 are shown as being formed integrally in one piece relationship with their respective spherical heads 32 and 46, they may be formed as a separate element/elements which is/are inserted into and/or attached onto their respective spherical heads, and they may be formed of the same or dissimilar materials as their spherical heads.

The second embodiment as shown in FIG. 3 is substantially the same as that shown and described in FIGS. 1 and 2 with the exception of the manner in which the input drive pin 14 and output drive pin 24 are held in the input coupling 12, output coupling 22 and the coupler 18. Accordingly like references numerals will be employed for components which are substantially identical to the embodiment of FIGS. 1-2, and where any such components have been modified in any substance the reference numerals will be primed, and additional reference numerals will be used for components which are found only in the embodiment of FIG. 3 and not the embodiment of FIGS. 1-2.

The principal difference between the embodiment shown in FIG. 3 and that shown in FIGS. 1-2 is that the set screws 16 and 26 as seen in FIGS. 1 and 2 have been eliminated together with the threaded passages 42 in the input coupling 12′ and output coupling 22′ into which they were threaded. Accordingly, the input coupling 12′ and output coupling 22′ may be solid in cross section with the exception of the openings 40 and 52 because the set screws 16 and 26 are not employed in this embodiment. Instead, the input drive pin 14 and output drive pin 24 are held in their respective openings 62 and 66 in the coupling 18′ and against movement along their axis by a cylindrical tube or sleeve 70 which is heat shrunk over the outer surface 72 of the coupler 18′ and over the ends of the input drive pin 14 and output drive pin 24 to seal the drive pins into their openings 62 and 66 in the coupler 18′ as seen in FIG. 3. In order to prevent the shrunken tube 70 from moving longitudinally of the coupler 18′, the outer surface 72 of the coupler preferably includes an annular ridge 74 as seen in FIG. 3.

The heat shrink tubing or sleeve 70 is preferably of polyvinyl chloride. However, it will be appreciated that other materials which shrink upon heating, for example with a flame, may be employed, such as polyolefins.

It will be appreciated that some other form of constraint may be applied over the coupler 18′ so long as it may be secured over the outer surface 72 of the coupler and over the input drive pin 14 and output drive pin 24 in a manner to prevent the removal of those drive pins from the openings 62 and 66. For example, such constraint may take the form of a narrow band over each of the pins 14 and 24 specifically, or may be fixed over those pins by threading onto or adhesively attached to the outer surface 72.

From the foregoing, it will be appreciated that the present invention is capable of effectively canceling the angular velocity difference between an input shaft 10 and output shaft 20 of a universal joint system through a range of motion while using radial bearing arrangement on only one of the shafts. And, this is achieved without adding extra weight, or an increase in space requirements or cost.

It will also be understood that the preferred embodiment of the present invention which has been described is merely illustrative of the principles of the present invention. Numerous modifications may be made by those skilled in the art without departing from the true spirit and scope of the invention.

I claim:

1. A constant velocity universal joint system comprising:
an input universal joint including an input shaft;
an output universal joint including an output shaft;
a coupler coupling said input universal joint to said output universal joint; and
wherein said input and output shafts are positioned relative to each other so that they engage each other to support each other when at least one of said shafts is moved at an angle relative the other shaft.

2. The universal joint system of claim 1, wherein:
said input universal joint also includes an input coupling and an input drive pin;
said output universal joint also includes an output coupling and an output drive pin;
said input drive pin coupling said input coupling to said coupler, and said input coupling coupling said input shaft to said input drive pin such that said input shaft can both tilt and rotate relative to said input drive pin;
said output drive pin coupling said output coupling to said coupler, and said output coupling coupling said output shaft to said output drive pin such that said output shaft can both tilt and rotate relative to said output drive pin; and
said input and output shafts engage each other to support said shafts when at least one of said shafts tilts or rotates relative to its drive pin.

3. The universal joint system of claim 2, including a projection on an end of one of said shafts, and a receptacle on an end of the other of said shafts, said projection extending into said receptacle and contacting said receptacle when at least one of said shafts tilts or rotates to support the shafts.

4. The universal joint system of claim 3, wherein said projection and said receptacle are substantially spherical.

5. The universal joint system of claim 2, wherein an end of said input and output shafts has a first opening to receive said input and output couplings respectively therein, and a second opening in said ends to receive said input and output drive pins respectively therethrough.

6. The universal joint system of claim 5, wherein said second openings are slotted to permit the ends of the input and output shafts to tilt relative to their respective drive pins.

7. The universal joint system of claim 5, wherein said ends of said input and output shafts which include said first and second openings are substantially spherical and are positioned in said coupler.

8. The universal joint system of claim 2, including at least one limit stop which limits the degree of tilt of said shafts.

9. The universal joint system of claim 8, wherein said limit stop is on said shafts.

10. The universal joint system of claim 8, wherein said limit stop is on said coupler.

11. The universal joint system of claim 8, wherein said limit stop is on both said shafts and said coupler.

12. The universal joint system of claim 2, wherein said drive pins are fixed against movement along their axis relative to said coupler.

13. The universal joint system of claim 2, wherein said drive pins are fixed against movement along their axis relative to said coupler by a screw in said input and output couplings, respectively.

14. The universal joint system of claim 2, wherein said drive pins are fixed against movement along their axis relative to said coupler by tubing surrounding the coupler.

15. The universal joint system of claim 14, wherein said tubing is shrunk about said coupler.

16. The universal joint system of claim 2, wherein said coupler is tubular having a passage therethrough, and an end of said input and output shafts, said input and output couplings and said input and output drive pins are positioned in said passage.

17. The universal joint system of claim 16, including a projection on an end of one of said shafts, and a receptacle on an end of the other of said shafts, said projection extending into said receptacle and contacting said receptacle when at least one of said shafts tilts or rotates to support the shafts, and said projection and receptacle are positioned in said coupler passage.

18. The universal joint system of claim 17, wherein said projection and said receptacle are substantially spherical.

19. The universal joint system of claim 16, wherein an end of said input and output shafts has a first opening to receive said input and output couplings respectively therein, and a second opening in said ends to receive said input and output drive pins respectively therethrough, and said first and second openings are positioned in said coupler passage.

20. The universal joint system of claim 19, wherein said second openings are slotted to permit the ends of the input and output shafts to tilt relative to their respective drive pins.

21. The universal joint system of claim 16, including at least one limit stop which limits the degree of tilt of said shafts.

22. The universal joint system of claim 21, wherein said limit stop is on said shafts.

23. The universal joint system of claim 21, wherein said limit stop is in said coupler passage.

24. The universal joint system of claim 21, wherein said limit stop is on both said shafts and in said coupler passage.

25. The universal joint system of claim 16, wherein said drive pins are fixed against movement along their axis relative to said coupler.

26. The universal joint system of claim 16, wherein said drive pins are fixed against movement along their axis relative to said coupler by a screw in said input and output couplings.

27. The universal joint system of claim 16, wherein said drive pins are fixed against movement along their axis relative to said coupler by tubing surrounding the coupler.

28. The universal joint system of claim 27, wherein said tubing is shrunk about said coupler.

29. The universal joint system of claim 16, wherein said ends of said input and output shafts which include said first and second openings are substantially spherical and are positioned in said coupler passage.

30. A constant velocity universal joint system comprising:
an input universal joint including an input shaft, an input coupling, and an input drive pin;
an output universal joint including an output shaft, an output coupling, and an output drive pin;
a tubular coupler coupling said input universal joint to said output universal joint, said tubular coupler having a passage therethrough, and an end of said input and output shafts, said input and output couplings and said input and output drive pins being positioned in said passage;
said input drive pin coupling said input coupling to said coupler, and said input coupling coupling said input shaft to said input drive pin such that said input shaft can both tilt and rotate relative to said input drive pin;
said output drive pin coupling said output coupling to said coupler, and said output coupling coupling said output shaft to said output drive pin such that said output shaft can both tilt and rotate relative to said output drive pin;
a substantially spherical projection on an end of one of said shafts and a receptacle on an end of the other of said shafts, said projection extending into said receptacle when at least one of said shafts tilts or rotates to engage each other to support each other, and said projection and receptacle being positioned in said coupler passage;
said end of said input and output shafts having a first opening to receive said input and output couplings respectively therein, and a second opening in said ends to receive said input and output drive pins respectively therethrough, said first and second openings also being positioned in said coupler passage, and said second openings are slotted to permit the ends of the input and output shafts to tilt relative to their respective drive pins;
at least one limit stop which limits the degree of tilt of said shafts, and said limit stop is on said shafts and/or in said coupler passage;
said ends of said input and output shafts which include said first and second openings are substantially spherical and are positioned in said coupler passage; and
said drive pins are fixed against movement along their axis relative to said coupler.

31. The universal joint system of claim 30, wherein said drive pins are fixed against movement along their axis relative to said coupler by a screw in said input and output couplings.

32. The universal joint system of claim 30, wherein said drive pins are fixed against movement along their axis relative to said coupler by heat shrinkable tubing which is heat shrunk about the coupler.

33. A constant velocity universal joint system comprising:
an input universal joint including an input shaft, an input coupling, and an input drive pin;
an output universal joint including an output shaft, an output coupling, and an output drive pin; a tubular coupler coupling said input universal joint to said output universal joint, said tubular coupler having a passage therethrough, and end of said input and output shafts, said input and output couplings and said input and output drive pins being positioned in said passage;
said input drive pin coupling said input coupling to said coupler, and said input coupling coupling said input shaft to said input drive pin such that said input shaft can both tilt and rotate relative to said input drive pin; and
said output drive pin coupling said output coupling to said coupler, and said output coupling coupling said output shaft to said output drive pin such that said output shaft can both tilt and rotate relative to said output drive pin.

34. A method of substantially eliminating a pulsating angular velocity difference in a universal joint system, comprising:
providing an input universal joint including an input shaft, an output universal joint including an output shaft, and a coupler coupling the input universal joint to the output universal joint; and
engaging the input and output shafts with each other to support each other when at least one of the shafts is moved at an angle relative to the other shaft.

35. The method of claim 34 wherein:
the input universal joint also includes an input coupling and an input drive pin; the output universal joint also includes an output coupling and an input drive pin;
engaging the input and output shafts with each other to support each other when at least one of the shafts tilts or rotates relative to its drive pin.

36. The method of claim 34, wherein a projection on an end of one of the shafts extends into a receptacle on an end of the other of the shafts so that the projection engages the receptacle when at least one of the shafts is moved at an angle relative to the other shaft to support each other.

37. The method of claim 36, wherein the projection and the receptacle are substantially spherical.
